(19) United States
(12) Patent Application Publication
(10) Pub. No.: US 2011/0264690 A1
(43) Pub. Date: Oct. 27, 2011

(54) INFORMATION PROCESSING DEVICE AND METHOD FOR DISTRIBUTING OBJECTS BETWEEN SYSTEMS

(75) Inventors: CHANG-GEN FANG, Shenzhen City (CN); FENG LIU, Shenzhen City (CN); BO LIU, Shenzhen City (CN)

(73) Assignees: HON HAI PRECISION INDUSTRY CO., LTD., Tu-Cheng (TW); GDS SOFTWARE (SHENZHEN) CO.,LTD, ShenZhen City (CN)

(21) Appl. No.: 12/965,180

(22) Filed: Dec. 10, 2010

(30) Foreign Application Priority Data
Apr. 26, 2010 (CN) 201010155952.2

(51) Int. Cl. G06F 17/30

(52) U.S. Cl. 707/769; 707/E17.014

(57) ABSTRACT

An information processing device and method for distributing objects from a source system to a destination system package at least one distribution object and at least one association object. The information processing device sets the at least one distribution object, the source system and the destination system. Then, the information processing device searches the at least one association object corresponding to the at least one distribution objects in the source system. After determining whether an anomaly in the at least one distribution object and the at least one association object is present between the source system and the destination system. If the anomaly is exited between the source system and the destination system, the information processing device packages corresponding association objects into a request number for distribution it.

### BACKGROUND

1. Technical Field

Embodiments of the present disclosure relate to data object distribution, and in particular, to an information processing device and a method for distributing objects from a source system to a destination system.

2. Description of Related Art

Companies often develop different software systems to maintain business and information safety, such as the Enterprise Resource Planning system (ERP). The software systems are developed to exchange data with other systems or databases. The exchanged data can include different kinds of objects. For example, the objects may be data elements, database field, database table, programs, function sets and function. In addition, an associative relationship among the objects, such as association objects correspond to the objects. For example, the objects may be the an employee name and the association objects are phone numbers, divisions and work ID correspond to the employee.

Version updates can be maintained by object synchronization. For example, some software systems need to be upgraded when new functions are released. In an update, the software system packages association objects and the to-be-transmitted objects from a source system to the destination system. However, in the process of synchronization, the system sometimes packages incomplete packages and transmits the incomplete packages between systems, defeating object synchronization efforts and affecting operation between the systems.

### BRIEF DESCRIPTION OF THE DRAWINGS

FIG. 1 is a block diagram of one embodiment of an information processing device comprising an object distribution system.

FIG. 2 is a block diagram of the object distribution system of FIG. 1.

FIG. 3 is a flowchart illustrating one embodiment of a method of distributing objects from a source system to a destination system using the information processing device.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or Assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

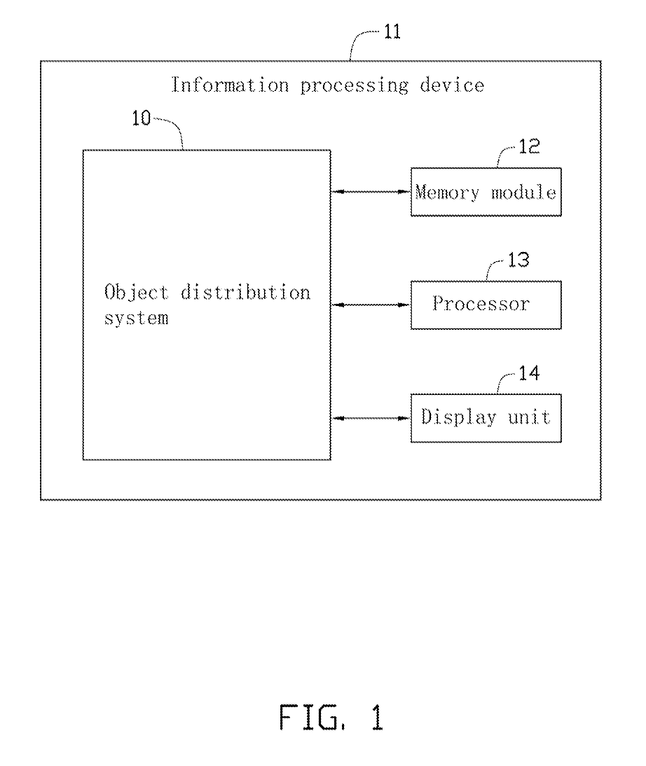

FIG. 1 is a block diagram of one embodiment of an information processing device 11 comprising an object distribution system 10. The information processing device 11 includes a memory module 12, a processor 13, a display unit 14 and the object distribution system 10. In one embodiment, the information processing device 11 can be a database server and the object distribution system 10 can be a database system. In other embodiments, the information processing device 11 may be a personal computer, an application server, or a workstation.

The information processing device 11 is generally controlled and coordinated by an operating system application, such as the UNIX, Linux, Windows 95, 98, NT, 2000, XP, Vista, Mac OS X, an embedded operating system, or any other compatible operating systems. In other embodiments, the information processing device 11 may be controlled by a proprietary operating system. Conventional operating systems control and schedule computer processes for execution, perform memory management, provide file system, networking, and I/O services, and provide a user interface, such as a graphical user interface (GUI), among other things.

The memory module 12 is electronically connected to the object distribution system 10, the processor 13, and the display unit 14. The memory module 12 is operable to save objects and information from the object distribution system 10 and the processor 13. In one embodiment, the objects and information are data elements, database fields, database tables, programs, function sets, and functions. For example, the data elements can be employee names, phone numbers and work IDs. The database fields can be employee name field, phone number field and work ID field. The employee name field includes a number of employee names, the phone number field includes a number of phone numbers and the work ID field includes a number of work IDs of the employees. The memory module 12 may include a hard disk drive, flash memory, RAM, ROM, cache, or external storage media.

The processor 13 is operable to execute one or more computerized codes of the object distribution system 10. The one or more computerized codes of the object distribution system 10 may be stored in the memory module 12 and executed by the processor 13. The processor 13, as an example, may include a CPU, math coprocessor, or shift register.

The display unit 14 is operable to display information of objects. In one embodiment, the display unit 14 can display a relationship between objects, for example, a relationship between a determined object and corresponding association objects by a tree diagram. Furthermore, the display unit 14 can display a flag to indicate an anomaly in objects between the source system and destination system.

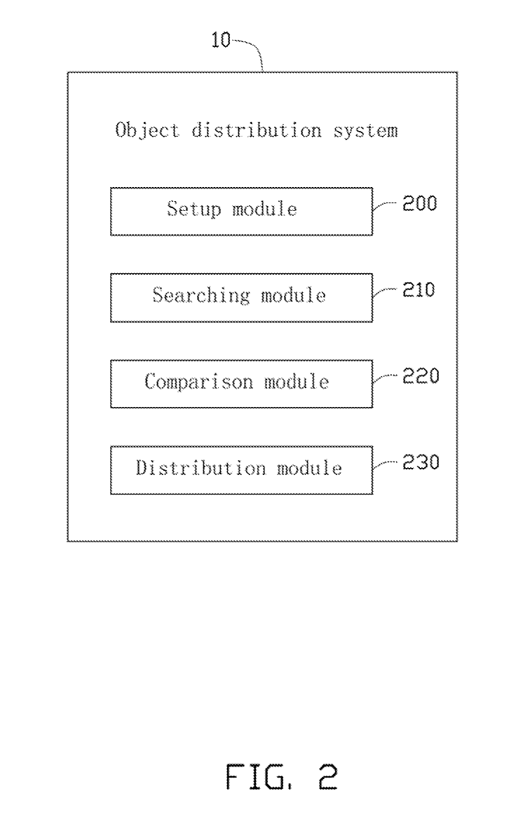

FIG. 2 is a block diagram of the object distribution system 10 of FIG. 1. The object distribution system 10 is operable to distribute objects from a source system to a destination system. For example, the system can be a software system or a database system. As shown in FIG. 2, the object distribution system 10 includes a setup module 200, a search module 210, a comparison module 220 and a distribution module 230.

The setup module 200 is operable to set at least one distribution object, the source system and the destination system. In one embodiment, the software development system distributes an object A to the software testing system for testing. Accordingly, the setup module 200 sets the software development system as the source system, sets the software testing system as the destination system, and sets the object A as a distribution object.

For example, the object A may include a data element, a database field, a database table, a program, a function set and a function. In other embodiments, the setup module 200 can also set a request number to represent one or more distribution objects. For example, the setup module 200 can set the request number FDVK962290 to represent the object A being transmitted.

The search module 210 is operable to search at least one association object corresponding to the distribution objects in the source system. In one embodiment, The source system and the destination system may be a database system and a destination database. If objects are distributed in the database system as the source system, the search module 210 searches the database field as the association object corresponding to the data element object being a distribution object in the source system.

In other embodiments, the source system contains a table for storing the data elements. The table of the source system comprises the database fields and entries. For example, the database field may be the employee name and the association objects are the phone numbers, the divisions and the work ID correspond to the employee.

The search module 210 further searches the data elements in each database field of the database as the association objects corresponding to the database table objects being distribution objects. Furthermore, the search module 210 may search the data elements, database tables, programs, function sets and functions used in source codes of the program as the association objects corresponding to the program object in the source system. In other embodiments, the search module 210 searches the functions included in the function set as the association objects corresponding to the function set in the source system.

The search module 210 further searches the data elements, database tables, programs and functions used in source codes of the function as the association objects corresponding to the function in the source system. The search module 210 further searches the programs as the association objects corresponding to the transaction code objects being the distribution objects in the source system.

The search module 210 searches for the association objects by a default search depth in databases and systems. For example, if a distribution object A is the data element and the default search depth is set to a 3 levels to search, such as searching a first level, a second level and a third level. The different levels comprise different types information of the databases. According to search the specific level of the databases, the search module 210 can search different types information in the databases. The search module 210 searches in a corresponding field in the first level, such as a field A1. The search module 210 continually searches in a corresponding database table in the second level, such as a database table A11. The search module 210 finally searches in corresponding database fields in the third level, such as database fields A111 and A112. In addition to the objects mentioned, the search module 210 further searches user-defined objects created in a development system or a database, such as a plug-in object defined by the user.

The comparison module 220 determines whether a difference in each distribution object and its association object is present between the source system and the destination system. The comparison module 220 then compares the anomaly of the objects between the source system and the destination system. For example, the comparison module 220 determines the presence of the anomaly if one object is absent from the destination system but is present in the source system.

In detail, the comparison module 220 compares a version and a property of the database field between the source system and the destination system if the distribution object is a database field. The property of the database may be a database type, a user-defined data type, a staff_ID and a staff_name. If the distribution object is the data element, the comparison module 220 compares the version, the property and the corresponding field of the data element between the source system and the destination system. If the distribution object is the database table, the comparison module 220 compares the version, the property and each database field of the database table between the source system and the destination system.

If the distribution object is the program, the comparison module 220 compares the version, the property and source code of the program between the source system and the destination system. If the distribution object is the function set, the comparison module 220 compares the functions included in the function set between the source system and the destination system. If the distribution object is the function, the comparison module 220 compares the version, the property and source code of the function between the source system and the destination system.

The distribution module 230 is operable to package the distribution object and the at least one association object with a request number if the comparison module 220 detects that a anomaly of the distribution object and the association object is present between the source system and the destination system. In order to increase the flexibility of the package, the distribution module 230 further packages the user-defined object and at least one corresponding association object into the request number if the anomaly is detected.

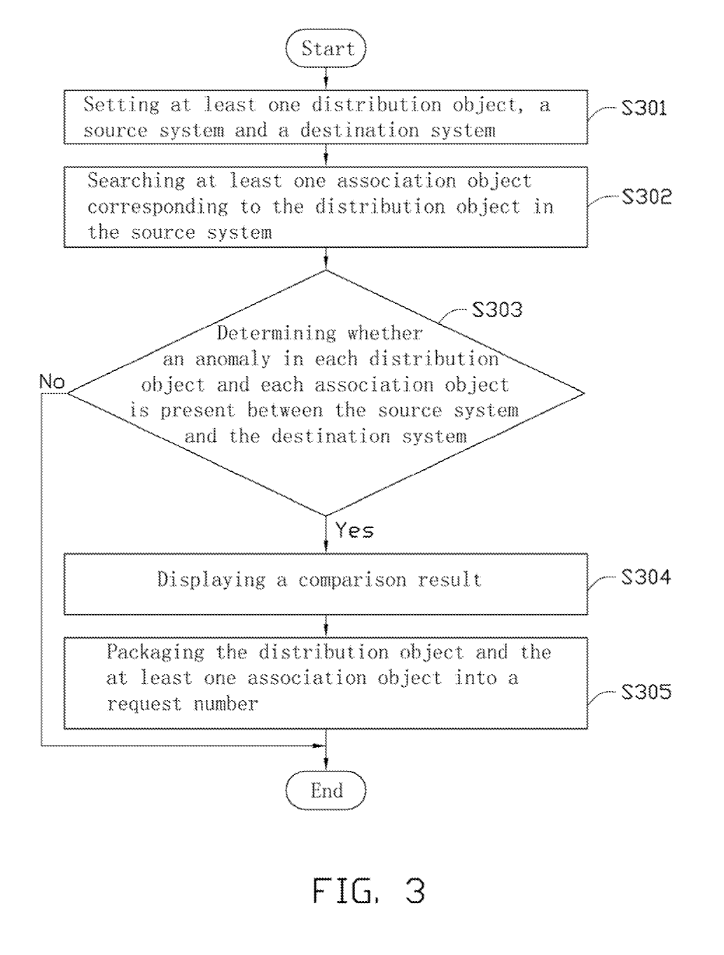

FIG. 3 is a flowchart illustrating one embodiment of a method of distributing objects from a source system to a destination system using the information processing device 11.

In block S301, the setup module 220 sets at least one distribution object, the source system and the destination system. In one embodiment, the software development system distributes an object A to the software testing system for testing. Accordingly, the setup module 200 sets the software development system as the source system, sets the software testing system as the destination system, and sets the object A as a distribution object.

For example, the object A can include a data element, a database field, a database table, a program, a function set, a function and a transaction code. In other embodiments, the setup module 200 can set a request number to represent one or more distribution objects. For example, the setup module 200 can set the request number FDVK962290 to represent the object A being transmitted.

In block S302, the search module 210 searches association objects corresponding to the distribution objects in the source system. In one embodiment, if the data element object is a distribution object and the corresponding association object is the database field. The search module 210 searches the database field in the source system.

Furthermore, if the program object is the distribution object and the corresponding association object are the data elements, database tables, programs, function sets and functions. The search module 210 searches the data elements, database tables, programs, function sets and functions used in source codes of the program as the association objects corresponding to the program object in the source system. Accordingly, the search module 210 searches the association objects by a default search depth.

For example, if a distribution object A is the data element and the default search depth is set to a 3 levels to search, such as searching a first level, a second level and a third level. The search module 210 searches in a corresponding field in the first level, such as a field A1. The search module 210 continually searches in a corresponding database table in the second level, such as a database table A11. The search module 210 finally searches in corresponding database fields in the third level, such as database fields A111 and A112. In addition to the objects mentioned, the search module 210 further searches user-defined objects created in a development system or a database, such as a plug-in object defined by the user.

In block S303, the comparison module 220 determines whether an anomaly in each distribution object and each association object is present between the source system and the destination system. If an anomaly is present, block S304 is implemented. If not, the procedure is ended. In one embodiment, the comparison module 220 determines whether each distribution object and each association object is present in the destination system, then compares the anomaly of the object between the source system and the destination system.

For example, if the distribution object is the program, the comparison module 220 compares the version, the property and source code of the program between the source system and the destination system. If the distribution object is the function set, the comparison module 220 compares the functions included in the function set between the source system and the destination system. In other embodiments, the comparison module 220 determines the presence of the anomaly if one object is absent from the destination system but is present in the source system.

In block S304, the display unit 14 displays the comparison result if the anomaly is present. In one embodiment, the display unit 14 displays a flag to indicate the anomaly is present between the source system and the destination system.

In block S305, the distribution module 230 packages the distribution object and an at least one association object into a request number. In order to increase the flexibility of the package, the distribution module 230 further packages the user-defined object and at least one corresponding association object into the request number if the anomaly is detected.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An information processing device for distribution of objects from a source system to a destination system, comprising:
a processor;
a memory module;
a setup module to set at least one distribution object, the source system and the destination system;
a search module to search at least one association object corresponding to the at least one distribution object in the source system;
a comparison module to determine whether an anomaly in the at least one distribution object and the at least one association object is present between the source system and the destination system; and
a distribution module to package the at least one distribution object and the at least one association object into a request number if the comparison module detects that the anomaly is present between the source system and the destination system.

2. The information processing device of claim 1, further comprising:
a display unit to display a flag to indicate the anomaly is present between the source system and the destination system.

3. The information processing device of claim 1, wherein the at least one distribution object comprises a data element, a database field, a database table, program, a function set or a function.

4. The information processing device of claim 1, wherein the search module searches the at least one association object using a default search depth.

5. The information processing device of claim 1, wherein the at least one association object is a plug-in object.

6. A method for distribution objects from a source system to a destination system using an information processing device, the method comprising:
setting at least one distribution object, the source system and the destination system;
searching at least one association object corresponding to the at least one distribution object in the source system;
determining whether an anomaly in the at least one distribution object and the at least one association object is present between the source system and the destination system; and
packaging the at least one distribution object and the at least one association object into a request number if the anomaly is present between the source system and the destination system.

7. The method of claim 6, further comprising:
displaying a flag to indicate the anomaly is present between the source system and the destination system.

8. The method of claim 6, wherein the at least one distribution object comprises a data element, a database field, a database table, a program, a function set or a function.

9. The method of claim 6, wherein the at least one association object is searched using a default search depth.

10. The method of claim 6, wherein the at least one association object is a plug-in object.

11. A storage medium having stored thereon instructions that, when executed by a processor, causes the processor to perform a method of distribution objects from a source system to a destination system using an information processing device, the method comprising:
setting at least one distribution object, the source system and the destination system;
searching at least one association object corresponding to the at least one distribution object in the source system;
determining whether an anomaly in the at least one distribution object and the at least one association object is present between the source system and the destination system; and
packaging the at least one distribution object and the at least one association object into a request number if the anomaly is present between the source system and the destination system.

12. The storage medium of claim 11, the method further comprising:
displaying a flag to indicate the anomaly is present between the source system and the destination system.

13. The storage medium of claim 11, wherein the at least one distribution object comprises a data element, a database field, a database table, a program, a function set and a function.

14. The storage medium of claim 11, wherein the at least one association object is searched using a default search depth.

15. The storage medium of claim 11, wherein the at least one association object is a plug-in object.
